(19) United States
(12) Patent Application Publication
(10) Pub. No.: US 2023/0033772 A1
(43) Pub. Date: Feb. 2, 2023

(54) DATA STORAGE DEVICE

(71) Applicant: Jack Zezhong Peng, San Jose, CA (US)

(72) Inventor: Jack Zezhong Peng, San Jose, CA (US)

(21) Appl. No.: 17/391,457

(22) Filed: Aug. 2, 2021

(51) Int. Cl. H02J 50/10; G06F 1/18

(52) U.S. Cl. CPC H02J 50/10; G06F 1/182; H04B 10/501

(57) ABSTRACT

A data storage device is involved in data storage technology. The data storage device of present invention includes a data memory which is placed in a hermetic housing, a power interface of the data memory which is connected to the wireless power transmission unit, and a data transmission interface of the data memory which is connected to the wireless data transmission unit. The wireless power transmission unit and the data transmission unit are placed in the housing. The present invention avoids the damage to the data memory due to the oxidation of the internal conductors.

### FIELD

The present invention is related to data storage technology.

### BACKGROUND OF THE INVENTION

The memory based on anti-fuse technology is used for data backup and ultra-long-term products that can generally be stored for more than 100 years. If one uses conventional conductive wire interfaces, it is likely to cause poor contact due to the oxidation of metal conductors, resulting in the Permanent Memory Disk (PMD) failing prematurely. In addition, in order to achieve sufficiently long service life of the PMD product to be comparable with its core PM memory, one needs to strictly consider the packaging of the product which needs to be waterproof, moisture-proof, fire-proof, high-temperature-proof, material-degradable and aging-proof, and shock-proof.

### BRIEF SUMMARY OF THE INVENTION

The technical problem to be solved by the present invention is to provide a data storage device that can fully protect the memory.

The technical solution adopted by the present invention to the technical problem is that the data storage device which is placed in a hermetic housing, a power interface of the data memory which is connected to the wireless power transmission unit, and a data transmission interface of the data memory which is connected to the wireless data transmission unit. The wireless power transmission unit and the data transmission unit are placed in the housing.

Further, the sealed housing is provided with a light-transmitting window, and the wireless data transmission unit is an optical modem. Alternatively, the wireless data transmission unit is a capacitive coupling data transmission unit. Alternatively, the wireless data transmission unit is a radio frequency data transmission unit.

Further, the hermetic housing is sealed in an airtight manner. The hermetically sealed housing is evacuated. Alternatively, the sealed housing is filled with nitrogen or with an inert gas.

The beneficial effect of the present invention is that proper and tight protection is provided for the data memory, and the transmission of data and electric energy can be realized without mechanical contact, and the damage to the data memory due to the oxidation of the internal conductor is avoided.

### BRIEF DESCRIPTION OF THE DRAWINGS

FIG. 1 is a schematic diagram of the structure of Embodiment 1 of the present invention.

FIG. 2 is a schematic diagram of the structure of Embodiment 2 of the present invention.

FIG. 3 is a schematic diagram of the structure of Embodiment 3 of the present invention.

### DETAILED DESCRIPTION OF THE INVENTION

The data storage device of the present invention is placed in an insulated sealed housing, and the power interface of the data storage device is connected to the wireless power transmission unit. The wireless power transmission unit is a coupling coil arranged in the sealed housing and can be coupled to a coil outside the housing to power the data memory. The sealed enclosure is evacuated or filled with an inert gas to prevent oxidation of internal components.

### Embodiment 1

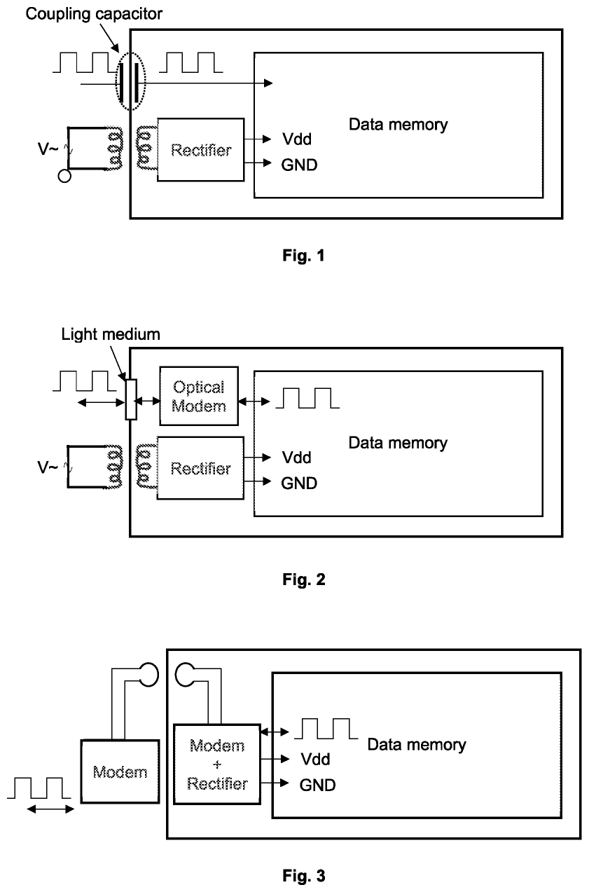

Referring to FIG. 1, the data transmission interface of the data memory is connected to the wireless data transmission unit. A simplified example of the wireless data transmission unit is a capacitor plate, which can form a capacitor with another capacitor plate outside the sealed housing to achieve penetrating data transmission in a sealed enclosure. The wireless data transmission unit may also use relatively complex and mature existing technologies such as WiFi and Bluetooth.

The power supply part of this embodiment adopts the coupling coil method to realize wireless power transmission.

### Embodiment 2

Referring to FIG. 2, the wireless data transmission unit of this embodiment adopts optical signal transmission technology, and a light medium window (such as transparent organic glass) is provided on the sealed housing as a transmission channel for optical signals. The power supply part adopts the method of coupling coil to realize wireless power transmission.

### Embodiment 3

Referring to FIG. 3, this embodiment adopts one set of coils to achieve two functions of data communication and power transmission. The modem, which comprises the antenna outside the sealed housing and the antenna inside the sealed housing, realizes data transmission. The antenna itself can also be used as a carrier for power transmission, by using prior arts extracting electric energy from the antenna.

In FIGS. 1-3, Vdd and GND represent high level and ground level, which are used to represent electrical energy. Square waves represent signals.

What is claimed is:

1. A data storage device, including a data memory which is placed in a hermetic housing, a power interface of the data memory which is connected to the wireless power transmission unit, and a data transmission interface of the data memory which is connected to the wireless data transmission unit. The wireless power transmission unit and the data transmission unit are placed in the housing.

2. The data storage device of claim 1, wherein the hermetic housing is provided with a light-transmitting window, and the wireless data transmission unit is an optical modem.

3. The data storage device of claim 1, wherein the wireless data transmission unit is a capacitive coupling data transmission unit.

4. The data storage device of claim 1, wherein the wireless data transmission unit is a radio frequency data transmission unit.

5. The data storage device of claim 1, wherein the hermetic housing is airtightly sealed.

6. The data storage device of claim 5, wherein the hermetically sealed housing is evacuated.

7. The data storage device of claim 5, wherein the hermetically sealed housing is filled with nitrogen.

8. The data storage device of claim 5, wherein the hermetically sealed housing is filled with an inert gas.
